(19) United States
(12) Patent Application Publication
(10) Pub. No.: US 2013/0270739 A1
(43) Pub. Date: Oct. 17, 2013

(54) METHOD AND APPARATUS FOR CONTROLLED SHRINKING OF PLASTIC SHEET MATERIAL

(71) Applicants: Miroslav Planeta, Mississauga (CA); Harinder Tamber, Brampton (CA)

(72) Inventors: Miroslav Planeta, Mississauga (CA); Harinder Tamber, Brampton (CA)

(21) Appl. No.: 13/842,001

(22) Filed: Mar. 15, 2013

Related U.S. Application Data
(60) Provisional application No. 61/624,117, filed on Apr. 13, 2012.

(51) Int. Cl. B29C 51/00; B29C 47/00

(52) U.S. Cl. CPC B29C 51/00; B29C 47/0057
USPC 264/280; 425/383; 425/174.4; 425/224

(57) ABSTRACT

Apparatus for controlled shrinking of molten plastic sheet material comprises a series of parallel cylindrical rollers for moving the plastic sheet material from a first position to a second position. At least one heater is aligned with the rollers for maintaining the plastic sheet material in a molten state while the rollers move the plastic sheet material, and a drive mechanism rotates the rollers so that the tangential speed of the rollers progressively decreases from the first position toward the second position. As a result of the progressive decrease in tangential speed of the rollers, the speed of the plastic sheet material is progressively reduced as the plastic sheet material approaches the second position, so that portions of the plastic sheet material closer to the second position move toward the second position more slowly than portions of the plastic sheet material further from the second position.

### CROSS-REFERENCE TO RELATED APPLICATION

The present application claims priority to U.S. Provisional Application No. 61/624,117 filed on Apr. 13, 2012, the teachings of which are hereby incorporated by reference.

### TECHNICAL FIELD

The present disclosure relates to processing of plastic sheet material, and more particularly to controlled shrinking of molten plastic sheet material.

### BACKGROUND

There is presently a demand to effectively control the shrinking of finished plastic films extruded from an annular or flat die.

### SUMMARY

The present disclosure describes a method for inducing longitudinal shrinkage in plastic sheet material. While maintaining the plastic sheet material at a temperature above its melting point, the plastic sheet material is moved in a longitudinal direction from a first position toward a second position. The speed of the plastic sheet material in the longitudinal direction is progressively reduced as the plastic sheet material approaches the second position so that portions of the plastic sheet material that are closer to the second position move toward the second position more slowly than portions of the plastic sheet material that are further from the second position.

The present disclosure also describes apparatus for controlled shrinking of molten plastic sheet material. The apparatus comprises a support structure and a series of parallel cylindrical rollers rotatably carried by the support structure. The rollers extend between a receiving position and a discharge position on the support structure for moving the plastic sheet material from the receiving position to the discharge position. The rollers are positioned relative to one another so as to define a notional travel surface for the plastic sheet material that is substantially tangential to each of the rollers, and are spaced from one another to define gaps between each pair of adjacent rollers. The gaps between the rollers are sufficiently small to inhibit the plastic sheet material from flowing through the gaps below the axes of rotation of the respective rollers during rotation of the rollers at operating speed. The apparatus further comprises at least one heater aligned with the series of rollers for maintaining the plastic sheet material in a molten state while the series of rollers move the plastic sheet material from the receiving position to the discharge position, and at least one drive mechanism coupled to the rollers for driving the rollers to rotate so that the tangential speed of the rollers progressively decreases from the receiving position to the discharge position.

In one exemplary embodiment, the series of rollers terminates at a receiving roller for receiving the plastic sheet material and which defines the receiving position and at a discharge roller for discharging the plastic sheet material and which defines the discharge position. In one implementation, the drive mechanism drives the receiving roller to have a greater tangential speed than any other roller, drives the discharge roller to have a lower tangential speed than any other roller, and drives each roller between the receiving roller and the discharge roller to have a tangential speed faster than the tangential speed of the adjacent roller that is closer to the discharge position and slower than the tangential speed of the adjacent roller that is closer to the receiving position.

In a particular exemplary embodiment, the at least one drive mechanism comprises at least one main drive motor drivingly coupled to each of the rollers through a transmission system. The transmission system may comprise a plurality of driven pulleys each coupled to one of the rollers for driving rotation of the respective roller and a drive belt that drivingly couples the at least one main drive motor to the driven pulleys for driving the driven pulleys and thereby rotating the rollers.

In another particular exemplary embodiment, the at least one drive mechanism comprises a plurality of drive motors each coupled to one of the rollers so that each roller is driven by its own drive motor.

In some embodiments the at least one heater comprises an infrared heater; in other embodiments the at least one heater comprises at least one hot air blower communicating with the series of rollers for blowing hot air into the gaps between the rollers from an underside of the series of rollers.

In some embodiments, in addition to one or more heaters, the apparatus is provided with at least one blower communicating with the series of rollers for blowing air into the gaps from an underside of the series of rollers.

In some embodiments, the apparatus includes an extruder arranged so that a die of the extruder is positioned to deliver the plastic sheet material to the receiving position. In other embodiments, molten plastic sheet material may be transferred to the apparatus from another process, or may be unwound from a roll and heated to a molten state before being delivered to the receiving position.

### BRIEF DESCRIPTION OF THE DRAWINGS

These and other features will become more apparent from the following description in which reference is made to the appended drawings wherein:

FIG. 1 is a schematic representation of a first exemplary apparatus for controlled shrinking of molten plastic sheet material;

FIG. 1A is an enlarged view of a portion of FIG. 1;

FIG. 2 is a side cross-sectional view of an exemplary physical implementation of the apparatus shown schematically in FIG. 1;

FIG. 2A is a detailed view of part of the exemplary physical implementation shown in FIG. 2;

FIG. 3 is a perspective view of an interior portion of the exemplary physical implementation shown in FIG. 2 with its heaters, blowers, ducts, plenums and shroud removed;

FIG. 3A is a detailed perspective view of part of the interior portion shown in FIG. 3, showing detail of part of the drive mechanism thereof;

FIG. 3B is a detailed perspective view of part of the interior portion shown in FIG. 3, showing arrangement of the rollers thereof; and

FIG. 4 is a schematic representation of a second exemplary apparatus for controlled shrinking of molten plastic sheet material.

### DETAILED DESCRIPTION

Apparatus as described herein may be used for controlled shrinking of molten plastic sheet material. As used herein, the term “molten” means that the temperature of the plastic sheet material is above the melting point for that particular material. In general, the apparatus as described herein will maintain the plastic sheet material in a molten state and, while the plastic sheet material is in a molten state, move the plastic sheet material in a longitudinal direction from a first position toward a second position while gradually slowing down the plastic sheet material. The speed of the plastic sheet material in the longitudinal direction is progressively reduced as the plastic sheet material approaches the second position, so that portions of the plastic sheet material that are closer to the second position move toward the second position more slowly than portions of the plastic sheet material that are further from the second position, resulting in a controlled shrinking of the plastic sheet material.

The types of plastic sheet material for which the methods and apparatus described herein may advantageously be used to effect shrinking include polymers such as polylactic acid (PLA), polyethylene (PE) including low, medium and high density polyethylene (LDPE, MDPE and HDPE, respectively) and linear low density polyethylene (LLDPE) and metallocene based linear low density polyethylene (mLLDPE), polystyrene (PS), ethylene vinyl acetate (EVA), polyvinyl chloride (PVC), polyvinyl butyral (PVB), acrylonitrile copolymer, plastomers (mPE), elastomers, thermoplastic polyolefin (TPO), thermoplastic polyurethane (TPU), fluoro-polymers, polypropylene (PP), nylon, polyethylene terephthalate (PET), cyclic olefin copolymer (COC), polyvinylidene chloride (PVDC) and ethylene vinyl alcohol (EVOH), as well as appropriate blends of the foregoing; one skilled in the art will appreciate that not all of the foregoing materials can be blended with one another. The plastic sheet material with which the apparatus and methods described herein may be used may also include suitable foams of the foregoing materials. The methods and apparatus described herein may be used with plastic sheet materials having thicknesses from about 0.001 inches to about 0.5 inches, and as such the term “plastic sheet material” includes not only thin plastic films but also thicker sheets. The term “plastic sheet material” also includes suitable co-extruded, laminated or extrusion coated plastic sheeting. Furthermore, while the methods and apparatus described herein are used with plastic sheet material in a molten state in which the plastic sheet material is inherently flexible, plastic sheet material processed using the methods and apparatus described herein may, following cooling, be flexible, semi-flexible or substantially rigid.

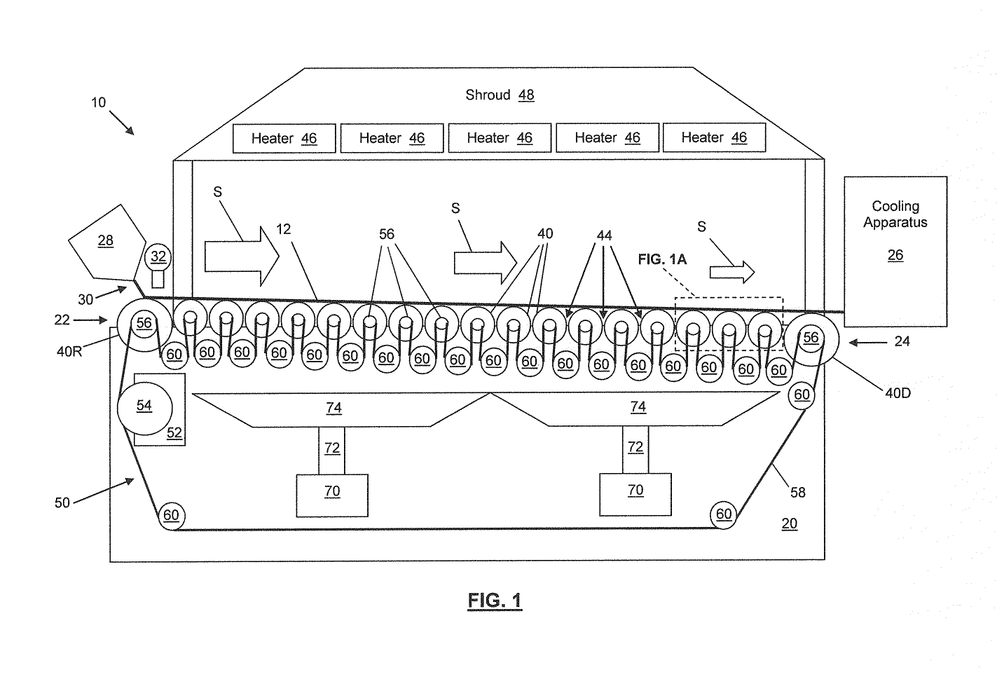

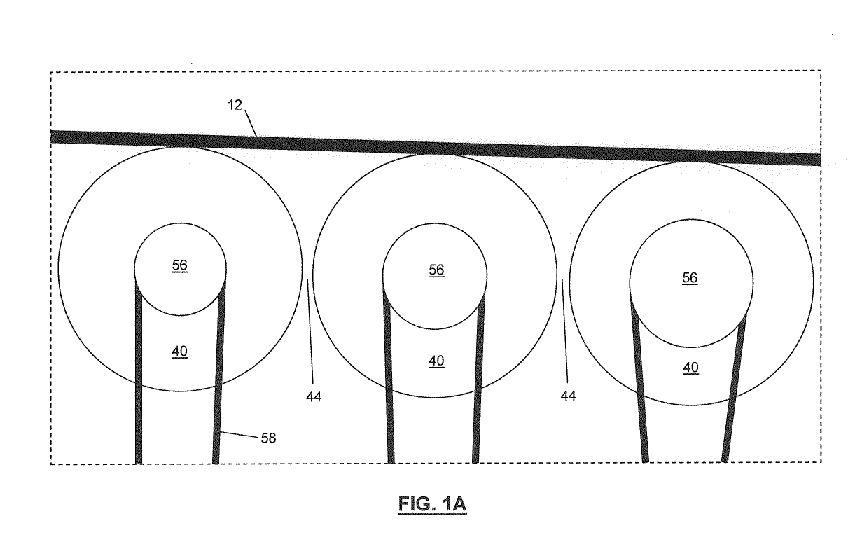

Reference is first made to FIG. 1, which illustrates schematically a first exemplary apparatus for controlled shrinking of molten plastic sheet material. The first exemplary apparatus is denoted generally by reference numeral 10, and the plastic sheet material is denoted by reference numeral 12.

The apparatus 10 comprises a support structure 20, and has a receiving position 22 for receiving the plastic sheet material 12 and a discharge position 24 for discharging the plastic sheet material 12, for example to a cooling apparatus shown as representative block 26. The cooling apparatus 26 may be, for example, one or more actively cooled rollers, air cooling apparatus, liquid bath cooling apparatus, or any other suitable cooling apparatus. In the exemplary illustrated embodiment, the apparatus 10 further comprises an extruder 28 arranged so that the die 30 of the extruder is positioned to deliver the plastic sheet material 12 to the receiving position 22 before the plastic sheet material 12 has had a chance to cool. Thus, the plastic sheet material 12 will be received at the receiving position 22 in a molten state. Optionally, an air knife 32 may be positioned downstream of the extruder 28 at or adjacent the receiving position 22. In other embodiments, instead of extruding the plastic sheet material 12 onto the receiving position 22, previously manufactured plastic sheet material in a solid state may be heated to a molten state and then delivered to the receiving position 22 of the support structure 20. For example, solid plastic sheet material may be unwound from a roll and passed across a heater adjacent to the receiving position 22 so that it will be in a molten state when it reaches the receiving position 22. Alternatively, plastic sheet material may be extruded and then cooled, for example in a liquid bath, and then passed across a heater for reheating to a molten state and then to the receiving position 22 in a single in-line process.

Continuing to refer to FIG. 1, the apparatus 10 further comprises a series of cylindrical rollers 40, 40R, 40D arranged with their respective axes of rotation parallel to one another. The rollers 40, 40R, 40D are rotatably carried by the support structure 20 and extend between the receiving position 22 and the discharge position 24 for moving the plastic sheet material 12 from the receiving position 22 to the discharge position 24. The series of rollers 40, 40R, 40D terminates at a receiving roller 40R located at the receiving position 22 and at a discharge roller 40D located at the discharge position 24. Accordingly, in the exemplary embodiment shown in FIG. 1 the receiving position 22 and the discharge position 24 are the respective positions where the plastic sheet material 12 is received by the series of rollers 40, 40R, 40D. The plastic sheet material 12 may be received from another apparatus having its own independent support structure, or from another apparatus carried by the same support structure 20 that carries the series of rollers 40, 40R, 40D. For example, the extruder 28 may have its own independent support structure or may be carried by the same support structure 20 that carries the series of rollers 40, 40R, 40D. Similarly, the plastic sheet material 12 may be discharged to another apparatus that has its own independent support structure, or to another apparatus carried by the same support structure 20 that carries the series of rollers 40, 40R, 40D. Thus, the cooling apparatus 26 may be carried by the same support structure 20 that carries the series of rollers 40, 40R, 40D or by an independent support structure.

In the illustrated embodiment shown in FIG. 1, the rollers 40, other than the receiving roller 40R and the discharge roller 40D, are each of equal diameter and are arranged with their axes of rotation being coplanar. The rollers 40, 40R, 40D are positioned relative to one another so as to define a notional travel surface for the plastic sheet material 12, with the notional travel surface being tangential to each of the rollers 40, 40R, 40D. In the exemplary embodiments shown herein, the notional travel surface is planar and slopes downwardly from the receiving position 22 toward the discharge position 24; such sloping may be advantageous in some circumstances but is not necessary. In other embodiments the notional travel surface that is tangential to the rollers may be curved. The extruder 28 delivers the plastic sheet material 12 to the receiving position 22 either on or adjacent the receiving roller 40R and the plastic sheet material 12 exits the apparatus 10 from the discharge roller 40D to, for example, the cooling apparatus 26.

The apparatus 10 further comprises a plurality of heaters 46 aligned with the series of rollers 40, 40R, 40D. The heaters 46 maintain the plastic sheet material 12 in a molten state while the rollers 40, 40R, 40D move the plastic sheet material 12 from the receiving position 22 to the discharge position 24. In the illustrated embodiment, the heaters 46 are infrared heaters. Infrared heating is preferred because the infrared radiation can effectively penetrate many types of plastic sheet material to heat the material through its entire thickness, rather than heating the surface and relying on heat conduction. However, any suitable type of heater may be used, such as blown hot air heaters or convection heaters, and either a single heater of suitable size or a series of smaller heaters may be used. Blown hot air heating may be used to particular advantage where the plastic sheet material is a thin film, and hot air is preferably delivered from underneath the rollers 40, 40R, 40D as described in more detail below. A shroud 48 surrounds the heaters 46 and the sides of the apparatus 10 to retain heat, with openings at the receiving position 22 for receiving the plastic sheet material 12 and at the discharge position 24 for discharging the plastic sheet material 12.

The rollers 40, 40R, 40D are spaced from one another to define gaps 44 between each pair of adjacent rollers 40, 40R, 40D. Although spaced from one another, the rollers 40, 40R, 40D are as close to one another as possible without actually engaging one another so that the gaps 44 are as small as possible. In particular, the gaps 44 are sufficiently small to inhibit the plastic sheet material 12 from flowing into the gaps 44 and falling below the axes of rotation of the respective rollers 40, 40R, 40D during rotation of the rollers 40, 40R, 40D at operating speed. Accordingly, the maximum permitted size of the gaps 44 will depend on the type of plastic sheet material 12, its viscosity and hence its temperature, and the tangential speed of the rollers 40, 40R, 40D. Calculation of suitable sizes for the gaps 44 given a known type of plastic sheet material 12, known viscosity/temperature and known tangential speeds of the rollers 40, 40R, 40D is within the capability of one skilled in the art, now informed by the herein disclosure.

The apparatus 10 further comprises a drive mechanism, generally denoted by the reference numeral 50, which is drivingly coupled to the rollers 40, 40R, 40D for driving the rollers 40, 40R, 40D at progressively decreasing tangential speeds from the receiving position 22 to the discharge position 24. Because the rollers 40, 40R, 40D move at progressively decreasing tangential speeds from the receiving position 22 to the discharge position 24, the speed of the plastic sheet material 12 in the longitudinal direction, that is, the direction from the receiving position 22 to the discharge position 24, is progressively reduced as the plastic sheet material approaches the discharge position 24. Accordingly, the portions of the plastic sheet material 12 that are closer to the discharge position 24 move toward the discharge position 24 more slowly than portions of the plastic sheet material 12 that are further from the discharge position 24, resulting in longitudinal shrinking of the plastic material. This progressive reduction in the travel speed of the plastic sheet material 12 as it moves from the receiving position 22 to the discharge position 24 is illustrated in FIG. 1 by the arrows “S” representing the relative speed of the associated portions of the plastic sheet material 12.

As noted above, the term “longitudinal direction”, as used herein, refers to the direction from the receiving position 22 to the discharge position 24, that is, the direction of motion of the plastic sheet material 12, which may or may not be the same as the direction in which the plastic sheet material 12 was extruded. As such, the apparatus and methods described herein may be used for controlled shrinking of plastic sheet material not only in the extrusion direction, but also, for example, transverse to the extrusion direction.

The rollers 40, 40R, 40D are of small diameter, preferably no more than about 4-5 inches each, although in some cases larger diameters may be used, depending on the type and thickness of the plastic sheet material being processed; larger rollers 40, 40R, 40D may be used where the plastic sheet material 12 is thicker. The rollers 40, other than the receiving roller 40R and the discharge roller 40D, are preferably all of identical diameter, as shown in FIG. 1, and in this case progressively decreasing tangential speeds can be achieved simply by driving the rollers 40 to rotate at progressively decreasing rotational speeds. In other embodiments rollers 40 of different diameters may be used so long as they are arranged to define a notional travel surface tangential to the rollers, and where a planar travel surface is desired the axes of rotation of the rollers can be vertically displaced from one another to compensate for the differing diameter, so that the tangential travel surface is planar. In embodiments with rollers of differing diameters, while the rollers would not necessarily rotate at progressively decreasing rotational speeds, the rotational speed of each roller would be set so that the tangential speeds of the rollers would progressively decrease from the receiving position to the discharge position. For example, by using rollers which progressively decrease in diameter from the receiving position to the discharge position, a progressive decrease in tangential speed may be achieved by rotating each roller at the same rotational speed.

The rollers 40, 40R, 40D propel the plastic sheet material 12 from the receiving position 22 toward the discharge position 24. The gaps 44, which are widest toward the upper surfaces of the rollers 40, 40R, 40D, leave the plastic sheet material 12 free to shrink, and the progressive decrease in tangential speed of the rollers 40, 40R, 40D facilitates this shrinking process. The controlled shrinking effect will depend on the composition and thickness of the plastic sheet material 12 as well as its temperature, which in turn depends on the temperature of the heaters 46, along with the amount of time taken for a given longitudinal point on the plastic sheet material 12 to move from the receiving position 22 to the discharge position 24. In general, because time is required for the desired shrinking to occur, with all other parameters being equal, the longer it takes for a given longitudinal point on the plastic sheet material 12 move from the receiving position 22 to the discharge position 24, the more shrinking will occur, up to an inherent limit for that material at that thickness and temperature. Calculation of suitable rotation speeds and temperatures to produce a desired shrinkage for a given plastic sheet material 12 of known thickness is within the capability of one skilled in the art, now informed by the herein disclosure.

In the exemplary embodiment shown in FIG. 1, the drive mechanism 50 comprises a single main drive motor 52, a drive pulley 54 driven by the drive motor 52, a plurality of driven pulleys 56 each coupled to one of the rollers 40, 40R, 40D for driving rotation of the respective roller 40, 40R, 40D, a continuous-loop drive belt 58 and a plurality of guide pulleys 60. The continuous-loop drive belt 58 loops around the drive pulley 54, the driven pulleys 56 and a plurality of guide pulleys 60. In the exemplary embodiment shown in FIG. 1, the guide pulleys 60 include a series of guide pulleys 60 arranged opposite the series of rollers 40, 40R, 40D, with the drive belt 58 interlaced between the guide pulleys 60 and the driven pulleys 56 to maintain tension and thereby maintain sufficient friction for the drive belt 58 to rotate the driven pulleys 56 and hence rotate the rollers 40, 40R, 40D. Thus, the drive motor 52 is drivingly coupled to the rollers 40, 40R, 40D by way of the driven pulleys 56, the guide pulleys 60 and the drive belt 58, to enable the drive motor 52 to rotate the driven pulleys 56 and thereby rotate the rollers 40, 40R, 40D. The diameter of the driven pulleys 56 progressively increases from the receiving position 22 toward the discharge position 24, so that the motion of the drive belt 58 will rotate the rollers at progressively decreasing tangential speed from the receiving position 22 toward the discharge position 24. Because the differences in tangential speed between adjacent rollers 40, 40R, 40D is preferably small, the differences in the diameter of the adjacent driven pulleys 56 is also small and hence is not visible in FIG. 1; FIG. 1A is an enlarged view of a portion of FIG. 1 that shows, in exaggerated form for illustrative purposes, the progressive increase in diameter of the driven pulleys 56 from the receiving position 22 toward the discharge position 24.

In alternative embodiments, the drive pulley 54 may be replaced by a drive gear, the driven pulleys 56 may be replaced by driven gears, and the drive belt 58 and guide pulleys 60 may be replaced by a suitable arrangement of intermeshing intermediate gears that drivingly couple the drive gear, and hence the drive motor 52, to the driven gears. Moreover, while the exemplary embodiment shown schematically in FIG. 1 shows the use of a single drive motor 52, in alternative embodiments, some of which are discussed below, more than one drive motor may be used.

Preferably, the driven pulleys 56 are sized, relative to the diameter of the respective rollers 40, 40R, 40D, so that the drive motor 52 drives the receiving roller 40R to have a tangential speed that is faster than the tangential speed of any other roller 40, 40D, drives the discharge roller 40D to have a tangential speed that is slower than the tangential speed of any other roller 40, 40R, and drives each roller 40 between the receiving roller 40R and the discharge roller 40D to have a tangential speed that is faster than the tangential speed of the adjacent roller 40, 40D that is closer to the discharge position 24 and slower than the tangential speed of the adjacent roller 40, 40R that is closer to the receiving position 22. In other embodiments, the driven pulleys 56 may be sized so that groups of rollers 40, 40R, 40D, rather than individual rollers 40, 40R, 40D, rotate at the same tangential speed. In such embodiments, the group of rollers 40, 40R that includes the receiving roller 40R has a tangential speed that is faster than the tangential speed of any other group of rollers 40, 40D, the group of rollers 40, 40D that includes the discharge roller 40D has a tangential speed that is slower than the tangential speed of any other group of rollers 40, 40R, and each group of rollers 40 between the group that includes the receiving roller 40R and the group that includes the discharge roller 40D has a tangential speed that is faster than the tangential speed of the adjacent group of rollers 40, 40D that is closer to the discharge position 24 and slower than the tangential speed of the adjacent group of rollers 40, 40R that is closer to the receiving position 22.

Blowers 70 are positioned to blow air at a suitable temperature into the gaps 44 from underneath the series of rollers 40, 40R, 40D. In the particular exemplary embodiment shown schematically in FIG. 1, the blowers 70 are in fluid communication with respective ducts 72 that carry air from the blowers 70 to respective plenums 74 that distribute the blown air across the undersides of the rollers 40, 40R, 40D so that the air can flow into the gaps 44 between the rollers 40, 40R, 40D. The blown air can, for example, assist in maintaining the plastic sheet material 12 in a molten state and in inhibiting the plastic sheet material 12 from sticking to the rollers 40, 40R, 40D.

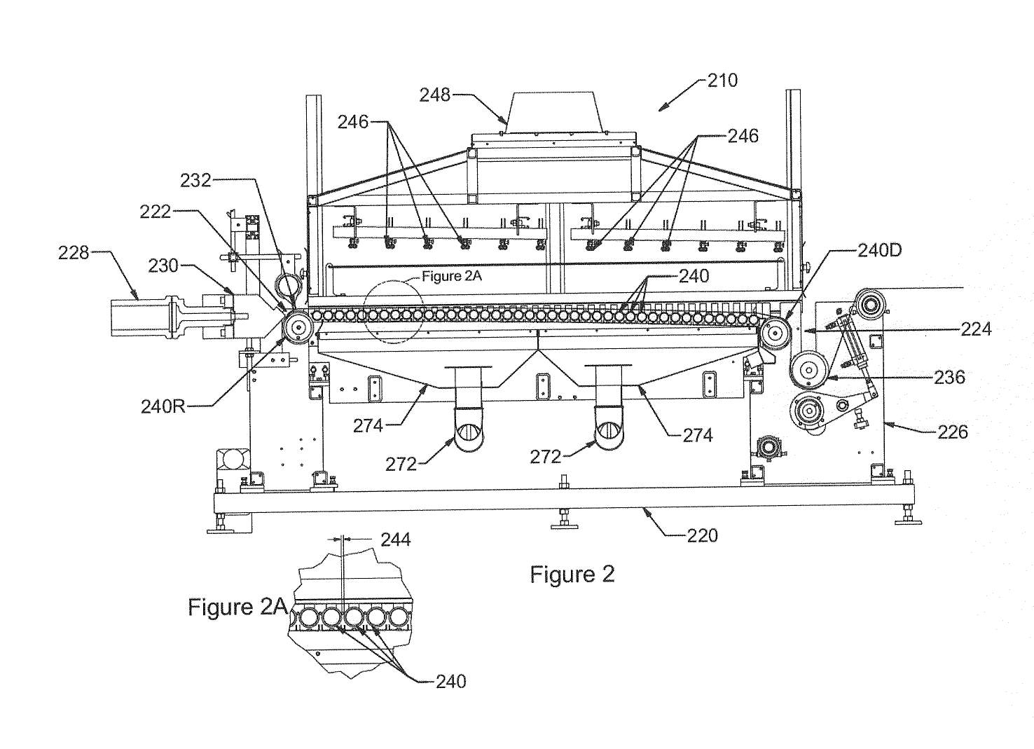

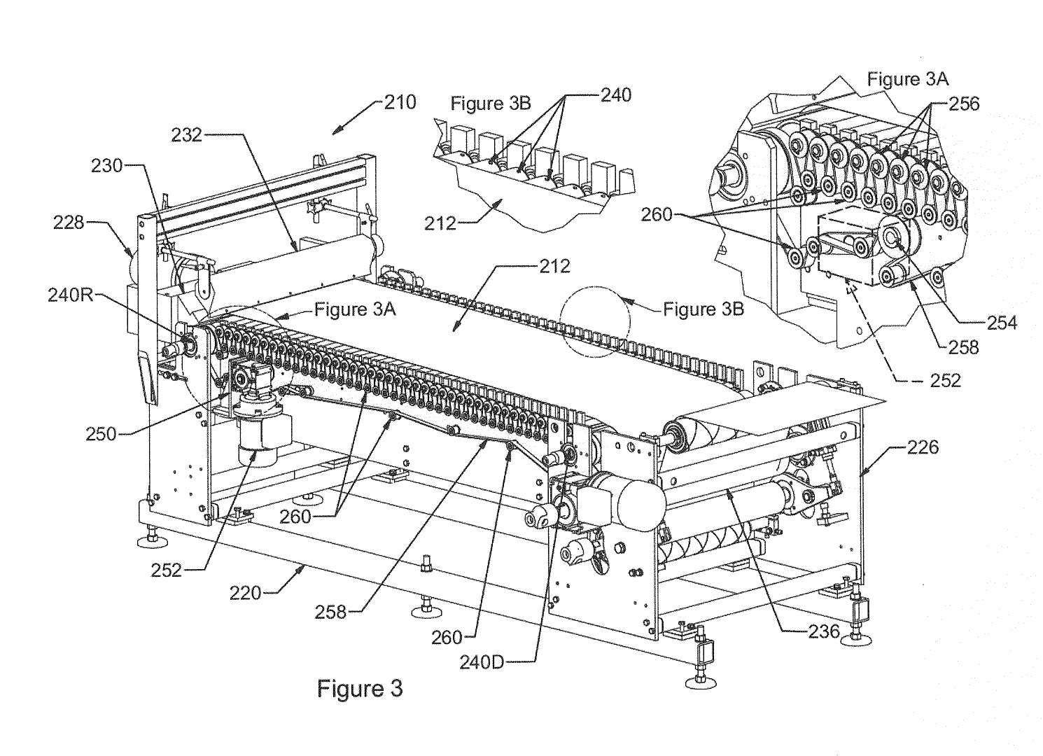

FIGS. 2 to 3B show an exemplary physical implementation of the apparatus shown schematically in FIG. 1. Accordingly, corresponding reference numerals are used to refer to corresponding features shown in FIG. 1, except with the prefix “2”. In FIGS. 2 to 3B, the cooling apparatus 226 comprises an actively cooled roller 236 to which the plastic sheet material 212 is fed after leaving the discharge roller 240D. FIG. 2A is an enlarged view of part of FIG. 2 and shows the gaps 44 between the rollers 40. FIG. 3 shows the interior portion of the apparatus 210, with the heaters 246, shroud 248, blowers, ducts 272 and plenums 274 removed to expose the rollers 240, 240R, 240D and the drive mechanism 250. FIG. 3A is a detail view with part of the drive motor 252 removed and part of the drive motor 252 shown in phantom to expose the drive pulley 254, and FIG. 3B is a detail view showing arrangement of the rollers 240 and the plastic sheet material 212. The blowers are not shown in FIGS. 2 to 3B; however the ducts 272 and the plenums 274 are visible in FIG. 2.

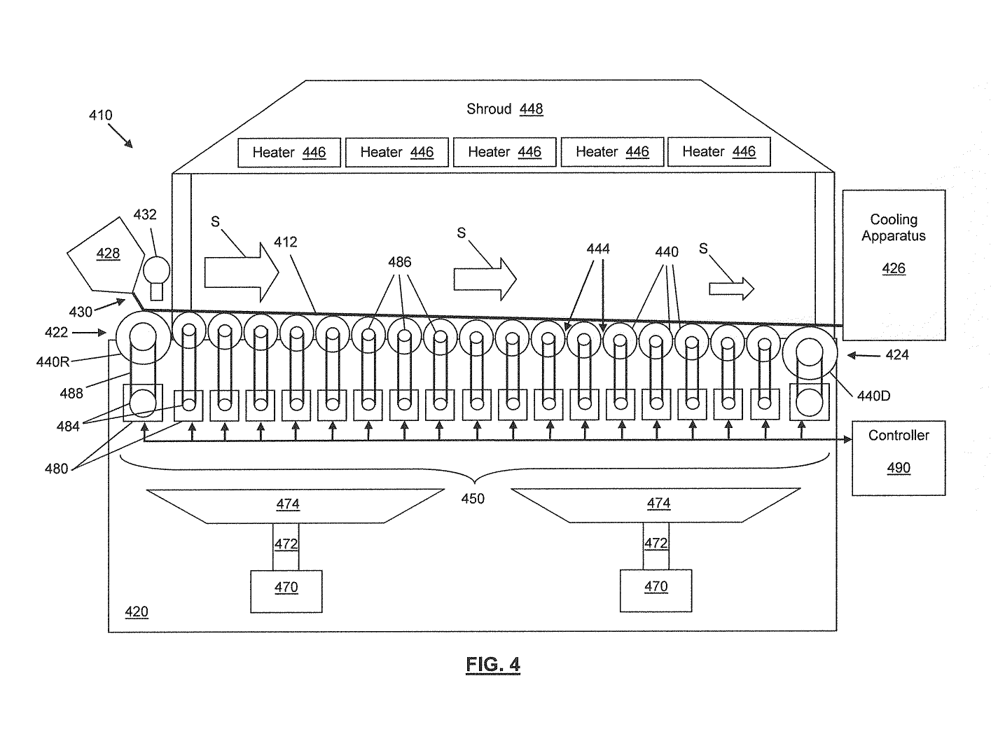

Reference is now made to FIG. 4, which illustrates schematically a second exemplary apparatus 410 for controlled shrinking of molten plastic sheet material. The second exemplary apparatus 410 is similar to the first exemplary apparatus 10, and corresponding reference numerals are used to refer to corresponding features except with the prefix “4”. The second exemplary apparatus 410 differs from the first exemplary apparatus 10 in that for the second exemplary apparatus 410, the drive mechanism 450 comprises a plurality of individual drive motors 480 drivingly coupled to the rollers 440, 440R, 440D so that each roller 440, 440R, 440D is driven by its own drive motor 480. In the illustrated embodiment, each drive motor 480 rotates a drive pulley 484 that is drivingly coupled by a continuous-loop drive belt 488 to a driven pulley 486 on the corresponding roller 440, 440R, 440D for driving rotation of that roller 440, 440R, 440D.

In a preferred embodiment, the drive motors 480 are coupled to a controller 490, such as a programmable logic controller or a suitably programmed general purpose computer, which controls the rotational speed of the individual drive motors 480 and thereby controls the rotational and hence the tangential speed of the rollers 440, 440R, 440D. The controller 490 may also receive feedback from the drive motors 480, for example to provide an alert in case of a malfunction. Thus, in one embodiment the drive motor 480 that drives the receiving roller 440R will drive the receiving roller 440R to rotate faster than any other roller 440, 440D, the drive motor 480 that drives the discharge roller 440D will drive the discharge roller 440D to rotate slower than any other roller 440, 440R, and the other drive motors 480 will drive each roller 440 between the receiving roller 440R and the discharge roller 440D to rotate faster than the adjacent roller 440, 440D that is closer to the discharge position and slower than the adjacent roller 440, 440R that is closer to the receiving position. Accordingly, the rollers 440, 440R, 440D move at progressively decreasing tangential speeds from the receiving position 422 to the discharge position 424, resulting in a progressive reduction in the travel speed of the plastic sheet material 412 as it moves from the receiving position 422 to the discharge position 424, as shown by the arrows “S” representing the relative speed of the associated portions of the plastic sheet material 412.

The use of a plurality of individual drive motors 480, 480R, 480D allows for more precise control of the tangential speed of the individual rollers 440, 440R, 440D, enabling the second exemplary apparatus 410 to be more easily adapted to generate different amounts of shrinkage or to handle different types and thicknesses of plastic sheet material 412.

In alternative embodiments, a plurality of drive motors may be provided, with each drive motor drivingly coupled to a group of rollers rather than a single roller. The rollers in each group may have driven pulleys of the same diameter so that all of the rollers in the group rotate at the same rotational speed. In one implementation of such an embodiment, the rollers in each group may have the same diameter so that each roller rotates at the same tangential speed, with the tangential speed of groups of rollers, rather than the speed of individual rollers, decreasing from the receiving position to the discharge position. In another implementation of such an embodiment, the rollers may progressively decrease in diameter from the receiving position to the discharge position so that the tangential speed of each roller in the group of rollers progressively decreases from the receiving position to the discharge position, even though the rollers are being rotated by the drive motor at a common rotational speed. Alternatively, the rollers in a given group may be of the same diameter but have driven pulleys that progressively increase in diameter from the receiving position to the discharge position, analogously to the embodiment shown in FIG. 1A, so that the tangential speed of each roller in the group of rollers progressively decreases from the receiving position to the discharge position, even though the group of rollers is being rotated by a single drive motor.

To prevent the molten plastic sheet material 12, 212, 412 from sticking to the rollers 40, 40R, 40D, 240, 240R, 240D, 440, 440R, 440D, a variety of techniques can be used, alone or in combination. For example, the rollers 40, 40R, 40D, 240, 240R, 240D, 440, 440R, 440D can be provided with a non-stick coating, the composition of which will depend on the particular type of plastic sheet material 12, 212, 412 with which the apparatus 10, 410 is to be used. The rollers 40, 40R, 40D, 240, 240R, 240D, 440, 440R, 440D can also be provided with rough surfaces, or made to vibrate at a suitable frequency; vibration of the rollers 40, 40R, 40D, 240, 240R, 240D, 440, 440R, 440D can also speed up the shrinking process. In addition, the air blown by the blowers 70, 470 toward the undersides of the rollers 40, 40R, 40D, 240, 240R, 240D, 440, 440R, 440D reduces pressure and contact between the plastic sheet material 12, 412 and the rollers 40, 40R, 40D, 440, 440R, 440D. The use of blown air also allows the gaps 44, 444 between adjacent rollers 40, 40R, 40D, 240, 240R, 240D, 440, 440R, 440D to be larger, since the blown air resists flow of plastic sheet material 12, 212, 412 into the gaps 444. The use of blown air is particularly advantageous where the plastic sheet material 12, 212, 412 is sticky in its molten state, such as where the plastic sheet material 12, 212, 412 is a copolymer with a high percentage of ethylene vinyl acetate (EVA) or plastomers or elastomers based on polyethylene (PE) or polypropylene (PP).

Where the plastic sheet material 12, 212, 412 is a thin film, i.e. from about 0.001 inch to about 0.010 inches thick, the blowers 70, 470 may be hot air blowers which provide the required heat to maintain the plastic sheet material 12, 412 in a molten state and therefore function as heaters such that a separate heater, e.g. heater 46, 246, 446, is not necessary.

In the illustrated embodiments, the heater 46, 246, 446, drive mechanism 50, 250, 450 and the optional blowers 70, 470 are carried by the respective support structure 20, 22, 420. In other embodiments, these components may not be carried by the respective support structure 20, 220, 420. For example, the heater 46, 446 may be suspended from a ceiling, and the optional blowers 70, 470 may be positioned on a floor.

Various currently preferred embodiments have been described by way of example. It will be apparent to persons skilled in the art that a number of variations and modifications can be made without departing from the scope of the appended claims.

What is claimed is:

1. Apparatus for controlled shrinking of molten plastic sheet material, comprising:
a support structure having a receiving position for receiving the plastic sheet material and a discharge position for discharging the plastic sheet material;
a series of parallel cylindrical rollers rotatably carried by the support structure and extending between the receiving position and the discharge position for moving the plastic sheet material from the receiving position to the discharge position;
each roller having an axis of rotation;
the rollers positioned relative to one another so as to define a notional travel surface for the plastic sheet material that is substantially tangential to each of the rollers;
the rollers spaced from one another to define gaps between each pair of adjacent rollers;
the gaps being sufficiently small to inhibit the plastic sheet material from flowing through the gaps below the axes of rotation of the respective rollers during rotation of the rollers at operating speed;
at least one heater aligned with the series of rollers for maintaining the plastic sheet material in a molten state while the series of rollers move the plastic sheet material from the receiving position to the discharge position; and
at least one drive mechanism coupled to the rollers for driving the rollers to rotate so that the tangential speed of the rollers progressively decreases from the receiving position to the discharge position.

2. The apparatus of claim 1, wherein:
the series of rollers terminates at a receiving roller for receiving the plastic sheet material and which defines the receiving position and at a discharge roller for discharging the plastic sheet material and which defines the discharge position;
the drive mechanism drives the receiving roller to have a greater tangential speed than any other roller;
the drive mechanism drives the discharge roller to have a lower tangential speed than any other roller; and
the drive mechanism drives each roller between the receiving roller and the discharge roller to have a tangential speed faster than the tangential speed of the adjacent roller that is closer to the discharge position and slower than the tangential speed of the adjacent roller that is closer to the receiving position.

3. The apparatus of claim 1, wherein the at least one drive mechanism comprises:
at least one main drive motor drivingly coupled to each of the rollers through a transmission system.

4. The apparatus of claim 3, wherein the transmission system comprises:
a plurality of driven pulleys each coupled to one of the rollers for driving rotation of the respective roller; and
a drive belt that drivingly couples the at least one main drive motor to the driven pulleys for driving the driven pulleys and thereby rotating the rollers.

5. The apparatus of claim 1, wherein the at least one drive mechanism comprises a plurality of drive motors each coupled to one of the rollers so that each roller is driven by its own drive motor.

6. The apparatus of claim 1, further comprising at least one blower disposed beneath the series of rollers for blowing air into the gaps between the rollers from an underside of the series of roller.

7. The apparatus of claim 1, wherein the at least one heater comprises an infrared heater.

8. The apparatus of claim 1, wherein the at least one heater comprises at least one hot air blower communicating with the series of rollers for blowing hot air into the gaps between the rollers from an underside of the series of rollers.

9. The apparatus of claim 1, further comprising an extruder arranged so that a die of the extruder is positioned to deliver the plastic sheet material to the receiving position.

10. A method for inducing longitudinal shrinkage in plastic sheet material, comprising:
while maintaining the plastic sheet material at a temperature above its melting point:
moving the plastic sheet material in a longitudinal direction from a first position toward a second position;
wherein the speed of the plastic sheet material in the longitudinal direction is progressively reduced as the plastic sheet material approaches the second location;
so that portions of the plastic sheet material that are closer to the second location move toward the second location more slowly than portions of the plastic sheet material that are further from the second location.
